(19) United States
(12) Patent Application Publication
(10) Pub. No.: US 2019/0325787 A1
(43) Pub. Date: Oct. 24, 2019

(54) LOW BREAKING LOAD CARE LABEL

(71) Applicant: AVERY DENNISON RETAIL INFORMATION SERVICES, LLC, Mentor, OH (US)

(72) Inventors: Andrea Felicioni, Spinetoli (IT); Mathieu de Backer, Grottammare (IT)

(21) Appl. No.: 16/388,133

(22) Filed: Apr. 18, 2019

Related U.S. Application Data
(60) Provisional application No. 62/659,430, filed on Apr. 18, 2018.

(51) Int. Cl. G09F 3/02

(52) U.S. Cl. CPC G09F 3/02; G09F 2003/0282

(57) ABSTRACT

The present invention relates to a garment care label having a low tensile strength and a soft hand feel. In one embodiment, the label may be inexpensive and may be easily torn in order to ensure that customers can easily and deliberately remove the label, or parts of the label, should the label or any part thereof be irritating or unnecessary. In some exemplary embodiments, the label may be formed from a woven or non-woven base material, such as viscose, natural fibers, or a blend, and may be coated with polyurethane in a dip coagulation coat process. The label may then be printed on using any of a variety of methods, such as thermal transfer printing, inkjet printing, or flexographic printing.

### CROSS REFERENCE TO RELATED APPLICATION(S)

The present application claims priority to and the benefit of U.S. provisional utility patent application Ser. No. 62/659,430 filed Apr. 18, 2018, which is incorporated herein by reference in its entirety.

### BACKGROUND

A substantial amount of articles of clothing sold in the United States and around the world contain one or more care tags or care labels. These care labels provide guidelines to consumers about how to care for their garments, apparel items and accessories, and the best cleaning procedures that can be applied to a particular combination of fabric, thread decoration, colors and construction techniques.

Many national regulations and international standards exist as to the content that must (or should) appear on these garment labels. These regulations and standards often are prepared with consumer protection in mind, and set forth bare minimum requirements that the labels must have in order to ensure that consumers are unlikely to damage their garments. These labels include both human readable indicia as well as symbols that are associated with treatment or care instructions, e.g. dry clean only, temperature, etc. Many manufacturers opt to exceed these bare minimum requirements; damage to garments from incorrect cleaning methods can often lead to complaints, costly customer returns of unsalable merchandise, and a bad overall image for the company. For example, a clothing brand would obviously not wish to have customers wearing clothing that has clearly been damaged in the wash emblazoned with their brand. Accurate and clearly written care labels, by contrast, can help ensure that clothing is properly maintained, and that the desired image for the brand owner is likewise maintained. Accurate and clearly written care labels can also serve as a cleaning guide and can influence customer purchasing decisions. Garments that are easy to care for can be much more attractive to customers than garments which are less easily cared for, which have complicated or difficult-to-understand instructions, or which require a different care method than the customer prefers. For example, while many customers look for the convenience of dry-cleaning, many others prefer the economy of washable garments.

The regulations defining the composition and placement of care labels generally require that the care labels be permanently attached to the garment so that they are easily accessible to the customer at the point of purchase. Usually, they are placed in an inconspicuous and out-of-the-way part of the garment that can be easily accessed at the time of cleaning, such as, for example, on the inside or bottom of the garment, generally towards the rear, or along an internal seam. Typical regulations and standards require that the labels include certain disclosure related to fiber content, country of origin, and manufacturer identity, as well as at least one set of washing instructions—potentially more than one if the garment can be cleaned through multiple methods. For example, a particular garment may be washed and dried in a conventional washing machine and tumble dryer, and may include care instructions for such a method, but may indicate that the user may have better results if they dry-clean the garment. This may indicate, for example, that the garment can be washed without damage, but that dry-cleaning may be better for maintaining the appearance and durability of the article.

In certain cases, however, customers may be irritated by the presence of a care label, and may wish to purchase garments without care labels. For example, many customers find care labels to be a nuisance because of where they are placed, add additional bulk to the waste line, or are placed poorly so as to be itchy and irritating to the consumer. This is often a problem with the labels on shirts, which are often placed in the back of the user's neck area, and which can be formed from a stiff fabric that will rub against and irritate the user's neck. However, other labels can also be poorly placed or poorly formed and can irritate the user in such a manner.

Customers may also find that they do not wish to retain the information on the garment care label on the garment itself, or may find that the garment tag is otherwise an inconvenience to them. For example, in some instances, a garment tag may stick out of the garment, or may be visible through the thin material of the garment. This may have an unappealing aesthetic effect, or may have other downsides; for example, some customers may be self-conscious about their garment size and may not wish to have this information on a visible tag that passerby could potentially view. Other customers may feel like having a visible garment tag having brand information displayed thereupon makes them a “walking advertisement” for that brand, or makes the garment less “personal.” Some customers may even be self-conscious about the tags in their clothing from a “conspicuous consumption” perspective; they may not wish to show that they (or perhaps their parents) have been shopping at less expensive stores or purchasing from less expensive brands, or may even wish to attach different tags to their clothing in order to imply that their clothes have been purchased from more expensive stores or more expensive brands. Some customers have also noted that these problems are most acute when dealing with clothing intended to be sold in multiple international markets; manufacturers may opt to use one uniform tag with care instructions and other information translated into multiple languages, which may dramatically enlarge the size of the tag and thus its potential adverse effects. This is most often the case with clothing that is designed to be sold in the European Union, or which originates there, as any clothing sold in the European Union must have attached labels translated into each member or selected country's language.

As such, many customers are opting to remove the tags from their clothing after purchase, or are opting to remove portions of the tags from their clothing after purchase, such as, for example, portions of the tags containing translations of the tag information into foreign languages. This is often a complicated process. For example, some customers indicate that they have to use nail scissors in order to snip the stitching around labels, and then have to use fine tweezers to pull out the threads around the labels. Other customers may wish to remove the labels, but may not be able to; it is a somewhat common practice with some garments to place a cover over a non-removable label (such as a Band-Aid®) in order to preserve the label without risking damage to the garment by removing it. In some cases, customers may simply find the labels redundant; they may have all of their clothing dry-cleaned regardless of whether the clothing can be put in a conventional washer and dryer, or may only purchase clothing that can be put in a conventional washer and dryer at certain settings or may only wish to retain care instruction information in clothing not meeting that description. In some cases, the information on the garment label may simply be available elsewhere; for example, some clothing may include RFID technology that allows information related to the garment (such as care instructions) to be retrieved from a website, eliminating the need for the label if the customer prefers to use the RFID solution.

Many manufacturers are attempting to move away from current labeling practices as well. Most current labels are formed from one of a few common fabric materials, such as satin polyester, TYVEK® fabric, or dip-coated acetate fabrics, because of attributes like the durability and cost of these materials. However, manufacturers have frequently observed that these materials are still a source of significant expense; many have opted to go as “tagless” as possible for these reasons. Some manufacturers have moved to using tagless plastic labels, usually included in the side seam of the garment, which offer a lower price (“fabric is expensive and plastic is cheap”) and do not feature any sewing edges. While this technology has been improved from its early days (where the ink used in tagless labels would potentially flake and become prickly after several washings or disappear after multiple washings), some manufacturers and customers may prefer different solutions, due to bad experiences with the earlier technology or due to reasons such as those discussed above.

### SUMMARY OF THE INVENTION

A low-breaking-load care label or a care label having a low tensile strength and a material for forming the same may be disclosed. According to an exemplary embodiment, a low tensile strength or breaking load care label may be constructed from a viscose-based, non-woven substrate, which may be coated using a coagulated coating process. This may result in the creation of a thermal transfer printable substrate that may be incorporated into a garment as a care label and can be relatively easily removed from the garments after they have been sewn in, allowing customers to easily cut out unwanted tags or unwanted portions of tags without risking damage to the garment itself. The care label may also, in some exemplary embodiments, present a softer hand feel than other tags currently available on the market, preventing irritation to the customer choose to leave the tag in the garment. With this special composition, the tag will feel softer after any washing process. This increase in softness is a result of the natural behavior of the cellulose (e.g., viscose) in the tag when it is in contact with the washing process (e.g., water).

According to an exemplary embodiment, a low breaking load or tensile strength care label may be constructed from a non-woven base material, such as viscose, a natural material, a blend of two or more such materials such as a blend of viscose and one or more natural materials or a blend of two or more natural materials, or any other material or combination of materials having the desired properties. According to an exemplary embodiment, this fabric material may be dip-coagulation coated in order to apply a protective coating; this protective coating may be formed from any suitable composition, such as a polyurethane dissolved in a solvent, a bio-polyurethane that does not require solvents, or a mix of the two.

According to an exemplary embodiment, the resulting label may be printed using thermal transfer, inkjet printing, or flexographic printing, or any other printing method such as may be desired. The resulting label may then be attached to the garment by sewing at the point of manufacture or other attachment means such as by ultrasonic welding. According to an exemplary embodiment, portions of the label may then be removed by a distributor or retailer prior to sale, once the garment has entered the country in which it will be sold, in compliance with standards and regulations; for example, if it is not necessary to provide translations of the care label language into multiple languages in the destination country, the portions of the care label that provide translations of the language into foreign languages may be torn out. In addition, the customer may remove the remaining care labels if they so choose.

In a further exemplary embodiment of the present disclosure, a low breaking load or low tensile strength woven label is described and includes a label material having at least a first surface and an end edge and is constructed of a material having a breaking load of less than approximately 130N. In some embodiments, the label first surface is printed with indicia relating to care of a garment or apparel item.

In a still further exemplary embodiment of the present invention, a method for making a low breaking load or low tensile strength woven label, is described and includes the steps of initially preparing a web of fabric having a breaking load strength ranging from approximately 90N to approximately 130N or from approximately 90N to approximately 150 N using a 2N tension. Next, the web of fabric is coated, dried and then printed. The web of fabric is then slit into rolls of material and each of the rolls is cut rolls into individual labels. Finally, the individual labels are affixed to a garment or apparel item.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 depicts an exemplary embodiment of a care label for a garment, which may have a low tensile strength;

FIG. 2 depicts an exemplary embodiment of a set of care labels for a garment, which may have a low breaking load or tensile strength;

FIG. 3 depicts an exemplary embodiment of a care label for a garment, which may have a low breaking load or tensile strength;

FIG. 4 depicts an exemplary embodiment of a care label for a garment, which may have a breaking load or low tensile strength; and

FIG. 5 is an exemplary flowchart depicting an exemplary embodiment of a method for forming a care label for a garment.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments of the disclosure”, “embodiments” or “invention” do not require that all embodiments of the invention include the discussed feature, advantage or mode of operation.

According to some embodiments, and referring generally to the Figures, various implementations of a low breaking load or low tensile strength care label for a garment may be disclosed.

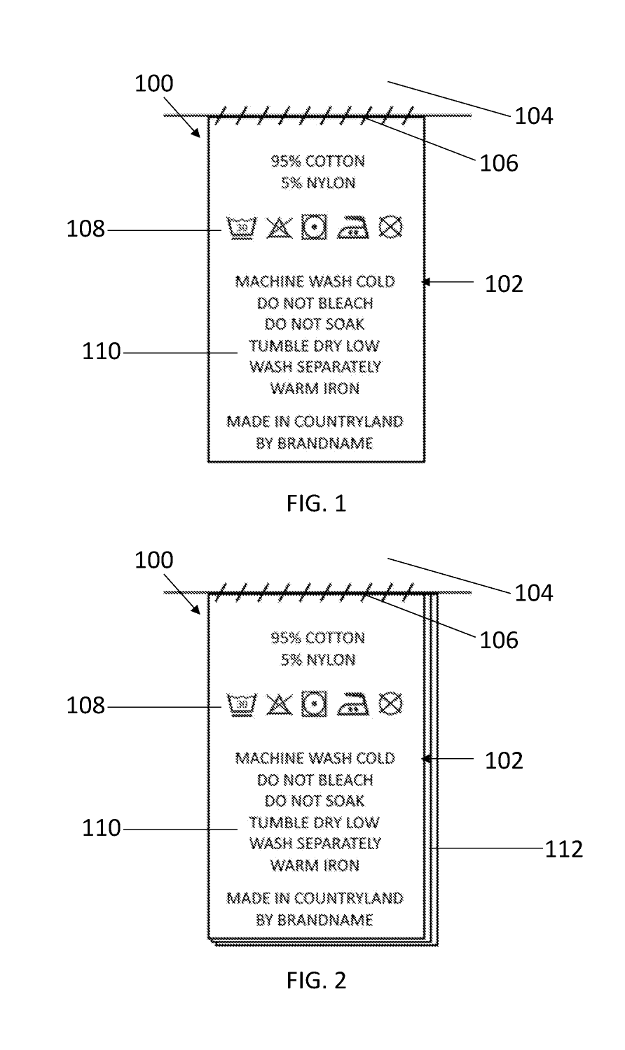

Turning now to exemplary FIG. 1, an exemplary embodiment of a low breaking load or low-tensile strength care label tag 100 may be provided in a garment or on another article. According to one embodiment, a low tensile strength care label tag 100 may be a label 102 constructed from a material having properties described herein, and may be coupled to the garment 104 by attachment means 106 such as sewing, stitching, ultrasonic welding or by another suitable attachment method known in the art such as, but not limited to, for example mechanical fasteners or staples.

According to other embodiments, a label 102 may be constructed from a woven or non-woven base material, which may be, for example, viscose, a natural material such as cellulose, a blend of viscose and natural material, or a blend of natural materials (or a blend of viscose or a natural material and some third material or set of materials). According to an exemplary embodiment, the base material may be dip coagulation coated with polyurethanes and solvents, bio-polyurethanes (which may not require the use of solvents), or a mix of polyurethanes and solvents and bio-polyurethanes in some quantity. In addition, the material may be coated on a wide web such as by coating fountains, curtains, spray, Meyer rods or other suitable means to apply the coating to the web.

In some embodiments, the resulting material may have the following properties. First, according to a tensile strength test (such as the ISO 13934-1:2013 tensile strength test), the material may have a tensile strength of approximately 90N, and up to approximately 150N, if prepared according to an embodiment of a method for preparing the label material as discussed herein. Some variation on this method for preparing the label material may be understood, based on exactly what fiber or combination of fibers is used to prepare the label material, and based on exactly what composition of polyurethanes and solvents or bio-polyurethanes is used to prepare the dip coagulation coating or other coating method. This approximately 90N to approximately 150N tensile strength label material may be compared to a standard label, which may have a breaking load or tensile strength of approximately four times the label of the present invention, e.g., approximately 360N for most labels presently used in the industry, such as standard dip-coated polyester/nylon labels.

The following table illustrates the performance of a breaking load test of the care label material of the present invention when performed on a strip of material 4 cm wide.

TENSILE STRENGTH
Determination of maximum force and elongation
at maximum force using the strip method

| Date start/end test: 29.03/30 Mar. 2018 | Warp | |
|---|---|---|
| Pretension, in N: | 2 | |
| Rote of jaw separation (mm/min) | 100 | mm/min |
| Length (mm): | 200 | mm |

| | |
|---|---|
| Number of specimens: | 5 |
| Number of rejected specimens: | 0 |
| Breaking load | 130N |
| Elongation | 20.0% |

Test executed in conditioned atmosphere on acclimatized material to 20° C. ± 2° C. and 65% ± 4% R.H.
Note:
strip width 4 cm

These figures are based on tests, conducted between Mar. 29, 2018, and Mar. 30, 2018, according to the ISO 13934-1:2013 method. The tests were conducted according to standard environmental conditions, in an environment of approximately 20 degrees Celsius, plus or minus 2 degrees Celsius, and at a relative humidity of at least 65%, plus or minus 4% relative humidity. A total of ten specimens were provided and used (five of the care label material and five of the reference material), with zero of the prepared specimens being rejected.

For reference, the ISO 13934-1:2013 method may be conducted as follows: ISO 13934-1:2013 specifies a procedure for determination of the maximum tensile force that a textile fabric can be subjected to, as well as the elongation that the textile fabric will be subjected to maximum force, based on the performance of a strip of the fabric (a “strip method”). The method may be applicable to woven or non-woven textile fabrics, such as fabrics that exhibit stretch characteristics, based on the presence of an elastomeric fiber in the fabric, or based on a mechanical or chemical treatment applied to the fabric. While it can be applied to fabrics produced by other techniques, it is not typically applicable to geotextiles, coated fabrics, textile-glass woven fabrics, and fabrics made from carbon fibers or polyolefin tape yarns, but may be, under certain circumstances, contemplated by the art. Fabrics may be tested in standard atmosphere in wet or dry states, and may be tested using a constant rate of extension (CRE) machine.

The fabric, in one embodiment presently contemplated, may be polyester, and may be prepared with a polyamide coating. Certain inks may be specifically prepared for printing on this material, specifically HS1111 and XC4111, and certain printers, such as the AVERY DENNISON® SNAP™ SERIES and the AVERY DENNISON® 6×6 printers, available from Avery Dennison Retail Information Services, LLC of Miamisburg, Ohio, and may be best suited to printing on this particular kind of label. (In certain exemplary embodiments, these printers may be used to print on the low tensile strength care label tag 100 material, and these ink compositions may be used in printing; alternatively, other printers or other ink compositions may be used, such as may be desired.) These labels may allow for thermal transfer printing and two-sided printing, allowing for a significant amount of flexibility in processing and significant efficiency in label size. The labels of the present invention may currently be used in garments where the softness of the care label is likely to be of some concern, and may be used in, for example, but not limited to, intimate apparel labels, children's and babywear labels, sports and leisurewear labels, and men's and women's outerwear labels. Labels may also be cut or severable with a cold knife without fraying, and may allow for high printing quality and wash resistance (up to 85 degrees Celsius), and may be readily dry cleaned.

Looking now at the ISO 13934-1:2013 tests, five 200 mm (20 cm) long and 40 mm (4 cm) wide strips of the low tensile strength care label tag 100 fabric were tested. It is important to note that while 200 mm is a standard length for the test procedure, 4 cm was chosen because it represents a standard length of a care label. According to the test as conducted, each of the five specimens was subjected to a 2 N pretension along its length in order to provide a sufficient tension to the specimen to hold it in place. The specimens were then loaded along their length by applying a rate of jaw separation of 100 mm per minute, in a direction tending to elongate the specimens. The specimens experienced an elongation of about twenty percent. Based on the tests, the low-tensile-strength label fabric, which, in these tests, showed an average breaking load of about 130 N and an average elongation at failure of about 20%.

In prior tests based on ISO 13934-1:2013 conducted between Jan. 30, 2018, and Feb. 1, 2018, five 200 mm (20 cm) long and 30 mm (3 cm) wide strips of material were tested alongside five 200 mm (20 cm) long and 30 mm (3 cm) wide strips of the low tensile strength care label tag 100 fabric. It is important to note that while, 200 mm is a standard length for the test procedure, 3 cm was chosen because it represents a standard length of a care label. According to these tests, each of the five specimens of each fabric was subjected to a 2 N pretension along its length in order to provide a sufficient tension to the specimen to hold it in place. The specimens of each fabric were then loaded along their length by applying a rate of jaw separation of 100 mm per minute, in a direction tending to elongate the specimens. The specimens experienced an elongation of about twenty percent. Based on these tests, the current label fabric showed an average breaking load of 360 N and an average elongation at failure of 26.5%. This may be compared with the low-tensile-strength label fabric, which, in these tests, showed an average breaking load of about 90 N and an average elongation at failure of 23.5%. As such, a low tensile strength care label tag 100 constructed from such a fabric may be significantly easier to tear.

Looking at the remaining elements shown in FIG. 1, a low tensile strength care label tag 100 may be prepared with label text 110 and other label information 108, such as visual care instructions, by thermal transfer printing, inkjet printing, flexographic printing, or by another printing method such as may be desired. Other label information 108 may include, for example, washing symbols, such as appears on the exemplary embodiment shown in FIG. 1. Specifically, the washing symbols shown in FIG. 1 may indicate that the garment is to be washed at a temperature of 30 degrees Celsius, that it should not be bleached, that it should be tumble-dried on a low setting, that it should be warm-ironed, and that it should not be dry cleaned. Other washing symbols may of course be used, and other washing symbol standards or regulations may also be used. For example, the washing symbols depicted in the exemplary embodiment of FIG. 1 may show symbols prepared according to the ASTM D5489-96c symbol chart, which requires laundering instructions to include, in order, a washing symbol, a bleaching symbol, a drying symbol, and an ironing symbol, as well as a dry-cleaning symbol. However, in other exemplary embodiments, symbols may be prepared according to a different standard. In some exemplary embodiments, symbol information and other instructions, or sets of symbol information and/or other instructions, may be prepared so that they may be easily separated from one another. For example, in an exemplary embodiment, the text instructions that may be provided on a label may be longer and as such may be provided under the pictographic instructions, so that the customer can trim off the text instructions that explain the symbols used for laundering and dry cleaning instructions if the customer feels that their care label tag is too large and should be trimmed down (in order to mitigate irritation or potential visibility of the tag).

In some exemplary embodiments, a low tensile strength care label tag 100 may include other information, such as information not related to washing or care of the garment at all. For example, the low tensile strength care label tag 100 may have additional information (such as at the bottom of the tag) which may provide the point of origin for the garment to which the low tensile strength care label tag 100 is attached, and may provide a brand name or manufacturer. As with the text instructions 110, in an exemplary embodiment, such information may be placed at a lower section of the tag or at the bottom of the tag, based on the reasoning that a customer may be most likely to want to remove brand information without removing any care information (on the grounds that customers may specifically want brand information to be removed from their clothing), and that customers who want to cut their low tensile strength care label tag 100 down to a smaller size by removing textual care instructions 110 will likely want to remove extraneous brand information as well.

In addition, other information may be added to the low-tensile-strength care label tags 100 that is not related to washing or care of the garment. For example, it is also contemplated to make use of these labels on items such as non-garment fabric, or even to use the label material for some purpose completely unrelated to garments. In these uses, information may be provided on the low-tensile-strength label tags that is not related to washing or care of the item. For example, it may be contemplated that a low tensile strength care label fabric material that is inexpensive, soft, tears well, retains ink well, and is resistant to moisture and washing may be used as a ticket or receipt material, such as a ticket to be used at a water park or amusement park where it is highly likely that the ticket will end up soaked in water while in the user's pocket. Other uses may include, for example, tear-away tabs for flyers, product packaging or gift wrapping, tearable wristbands for regulating customer entry into or exit from a venue, or any other potential uses such as may be envisioned.

Looking next at exemplary FIG. 2, FIG. 2 shows another exemplary embodiment of a low-tensile-strength care label 100 configuration. In such a configuration, an exemplary embodiment of a low-tensile-strength care label 100 may be provided as part of a stack of two or more care labels 112. In an exemplary embodiment, some of the care labels in the stack of two or more care labels 112 may be torn away by a retailer or distributor prior to sale, so that extraneous labels can be removed and so that the product can be sold with only those labels that it is legally required to have. Alternatively, the customer may be able to tear or cut away the extraneous labels on their own. Alternatively, it may be envisioned that, since users who want to retain only a portion of a label may want to retain different portions of a label, a product may be provided with a stack of two or more care labels 112 that are each in the same language and which feature the same information, but may provide it in different places. (For example, in one exemplary embodiment, a first label in the stack may be a full label, such as a low-tensile-strength care label tag 100 as provided in FIGS. 1 and 2.

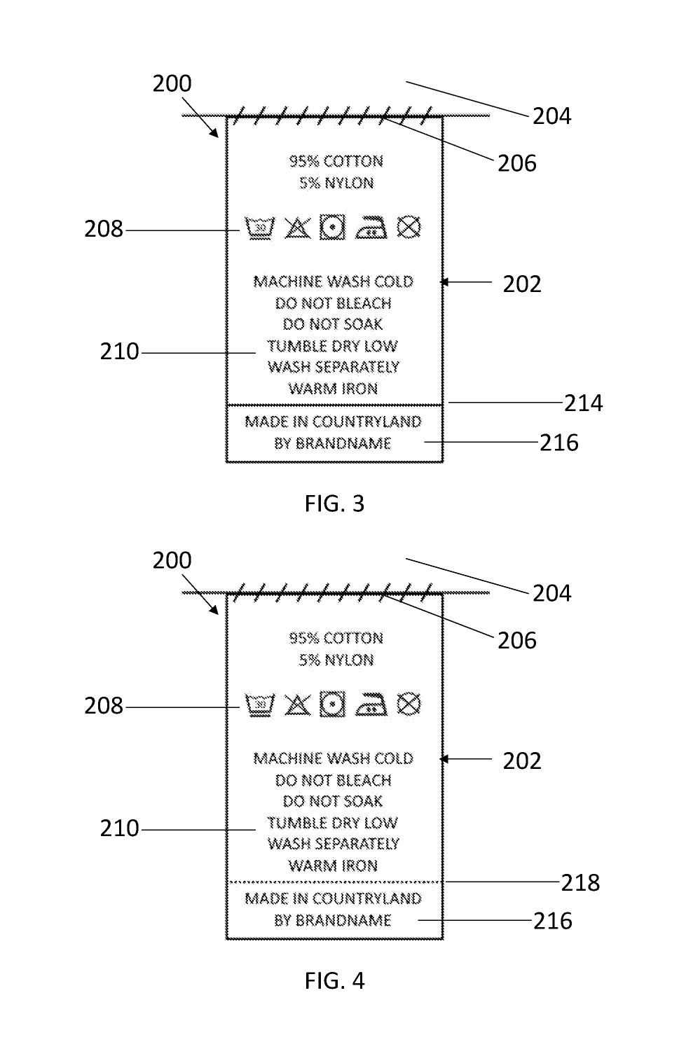

Looking next at exemplary FIGS. 3 and 4, in some exemplary embodiments, a low-tensile-strength care label tag 200 may be a label 202 constructed from a material having properties described herein, and may be coupled to a garment 204 by attachment means 206, such as sewing, stitching, ultrasonic welding or by another suitable attachment method known in the art such as, but not limited to, for example mechanical fasteners or staples. According to an exemplary embodiment, the low-tensile-strength care label tag 200 may be provided with pictographic instructions 208 and/or text instructions 210, such as may be desired.

According to an exemplary embodiment, a low-tensile-strength care label tag 200 may be provided with a weakened portion 218 (illustrated in FIG. 4) or a guideline 214 (illustrated in FIG. 3) by which a user can more easily cut or tear off an undesired portion 216 of the label 202. For example, a user may be able to make a clean cut parallel to the attachment means 206 by following a guideline 214 when cutting, or may be able to make a clean tear of the fabric by tearing along a weakened portion 218. In one embodiment presently contemplated, the weakened portion 218 is a plurality of perforations.

In the exemplary embodiments shown in FIGS. 3 and 4, the undesired portion 216 of the label 202 may be a portion featuring brand information and country of origin information, which may be required to be on the label for regulatory reasons but which customers may not care about or wish to have on their label. However, it may be contemplated that the undesired 216 portion of the label 202 may be any portion on the same label or on different labels in a label stack, or may be multiple portions, which may each be cut or torn off. For example, in one embodiment, each discrete section may have its own weakened portion 218 or its own guidelines 214 such that a user may cut, tear off, or otherwise remove the number of sections that they wish to remove. For example, a user may be able to tear off the marked undesired portion 216 by separating the label 202 along the guideline 214 or weakened portion 218 as drawn, or may be able to tear off the marked undesired portion 216 and the text instructions by separating the label 212 along another guideline 214 or another weakened portion 218 disposed higher up the label, and so forth.

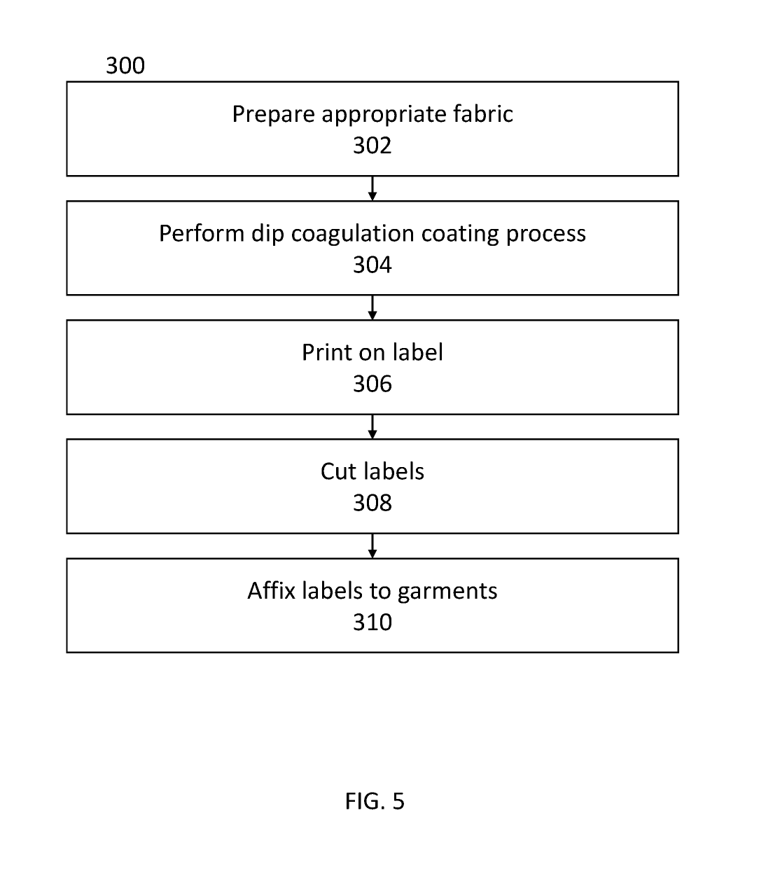

Turning next to exemplary FIG. 5, FIG. 5 is a flowchart depicting a method 300 for forming a care label such as, but not limited to, for a garment. In a first step 302, an appropriate fabric may be selected and prepared. As discussed above, an appropriate fabric may include, for example, a woven or non-woven base material, such as viscose, a natural material, or a blend.

In a next step 304, the material may be subject to a dip coagulation coating process or may be coated on a wide web or through any other suitable coating process, e.g., fountain, curtain, spray, or the like, in at least one of polyurethanes and solvents, or bio-polyurethanes. As previously discussed, the precise mechanics of a coating process may depend on the specific composition to be used by a manufacturer or other requirements of the manufacturer, but an exemplary embodiment of a polyurethane dip coagulation coating process is described below.

In a first step of one embodiment of a coagulation coating process, a completely reacted polyurethane solution of about 20%, mixed with appropriate solvents as known to those of ordinary skill in the art, may be mixed with any desired aqueous pigments, as well as with ionic polyurethane, which may function to promote coagulation, as well as a polyelectrolyte. Once this solution is prepared, it may be de-aerated prior to being used. Once this occurs, the fabric may be introduced into the polyurethane solution by dipping, at which point it may be removed from the polyurethane solution and introduced into a water bath. Once in the water bath, the polyurethane may coagulate. The fabric may then be removed from the water bath, and excess water may be removed from the fabric by a squeezing process. If other processes are used, the web of material will move in a machine direction through a coating or processing line where it may encounter a bath of material, fountain, curtain, spray or other coating method used to apply the coating to the web of material.

It may then be desired to apply a main coat of polyurethane to the fabric, which may be accomplished by knife coating or other suitable methods, such as Meyer rod, curtain, or fountain. The moist polyurethane-impregnated substrate with a coating of polyurethane. Steam or heat may then be passed over the fabric in order to gel the polyurethane applied via the coating and initiate coagulation of this material.

The coated fabric may then be introduced into another coagulation bath or reservoir, which in this case may only be mostly water and may include a quantity of dimethylformamide (DMF), a solvent miscible in water. Typically, DMF may be present in any quantity from approximately 15% to approximately 35%. After coagulation has finished, the fabric may be dipped in a water bath to remove DMF, and may then be washed in suction drums to further remove DMF. DMF may be recovered and reclaimed throughout this process. The wet fabric may then be dried, often in a tenter (a frame or endless track with hooks or clips along two sides, which may be used for drying and stretching cloth).

Various aspects of this process may be controlled in order to control the characteristics of the resulting final coated fabric product. For example, the type of polyurethane may be varied (as discussed); for example, bio-polyurethane may be used instead in some quantity. Likewise, the additives may be varied, if any are present. The viscosity and solid content of the solution may also be varied, as may be the type of fabric; a viscose fabric may have different ultimate properties than a natural cellulose fabric, and both may differ from a blend. The extent of the initial impregnation of the fabric with polyurethane, in a first dipping process prior to the application of the main coat, may also result in different properties, based on how long the fabric is left in the solution or the concentration of the polyurethane. Likewise, the concentration of the DMF in the bath, and the temperature at which coagulation is performed, may each have a different effect on the fabric, as may the total dip time and the time spent at each other stage of the process (such as the extent to which squeezing takes place to remove water from the fabric, or the drying time or conditions). The efficiency of each stage of the process may also affect the ultimate product, as well.

In some exemplary embodiments, it may be contemplated to impregnate and/or coat the fabric in another polymer, such as, for example, polyamide. In such an exemplary embodiment, the general coating and coagulation process may be similar to those that may be performed for polyurethane, but may use different solvents or may avoid the use of solvents (such as, for example, DMF) or may have other dissimilarities.

Once this coagulation process has finished, in a next step 306, the subject matter of the label may be printed onto the label. The subject matter may include human and/or machine readable indicia, symbols, numbers or other indicia which may be required by a brand owner or regulatory authority. According to an exemplary embodiment, this may be performed by thermal transfer; according to another exemplary embodiment, this may be performed by any other method as has been discussed, such as inkjet printing and flexographic printing. (Flexographic printing is a process that makes use of a flexible relief plate, similar to what might be used in a printing press, and which may be used to print on a wide variety of substrates including metallic films, plastic, and paper.)

In a next step 308, the webs may be cut or slit into strips of label material, with each web creating a number of label rolls. Alternatively, labels may be cut from a label sheet, if it is preferable to handle each label individually rather than handling the labels as a continuous roll. When cut into label rolls, the label rolls are then cut into individual labels. In some exemplary embodiments, labels may be cut to any size and shape; for example, square, rectangular, or rounded labels, as will be understood by a person of ordinary skill in the art, as well as any other label shapes that may be desired. A label may also be prepared with a weakened portion during a cutting stage, if desired.

In a next optional step 310, the labels may be sewn, stitched, welded, bonded or otherwise attached to a garment or other item. In some exemplary embodiments, multiple labels may be provided as a stack, or multiple labels may otherwise be provided and coupled to the garment. Where multiple labels are collected, they are usually assembled into a pad and then attached to the garment by one of the processes or attachment means set forth herein.

Once this has been completed, the label may be disposed in the garment, and may then be torn out or cut out by a customer or another party (such as a retailer in a jurisdiction that does not require at least one of the labels to be present) as desired.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A low tensile strength label, comprising;
a label material having at least a first surface and an end edge and constructed of a material having a breaking load of less than 150 N, where the label first surface is printed with indicia.

2. The label of claim 1, where the label is attached to a garment along the end edge by attachment means.

3. The label of claim 1, where the label comprises a care label.

4. The label of claim 1, where the label has a breaking load of 90 N to 150 N using a 2 N tension.

5. The label of claim 2, where the indicia is related to washing or care of the garment.

6. The label of claim 1, where the label material comprises a viscose-based non-woven substrate.

7. The label of claim 1, where the label is a ticket or receipt.

8. The label of claim 3 further comprising a stack of two or more care labels.

9. The label of claim 6, where the non-woven substrate is dip coagulation coated with one or more polyurethane and one or more solvent.

10. The label of claim 6, where the non-woven substrate is dip coagulation coated with one or more bio-polyurethane.

11. The label of claim 6, where the non-woven substrate is dip coagulation coated with a mix of one or more polyurethane, one or more solvent, and one or more bio-polyurethane.

12. The label of claim 6, where the non-woven substrate is coated on a wide web.

13. A method for making a low tensile strength label, comprising the steps of:
preparing a web of fabric having a breaking load strength ranging from 90 N to 150 N using a 2 N tension;
coating the web of fabric;
printing on the web of fabric;
cutting the web of fabric into two or more rolls of material; and
cutting each roll of material into individual labels.

14. The method of claim 13, further comprising affixing the individual labels to a garment or apparel item.

15. The method of claim 13, where the web of fabric is a non-woven material.

16. The method of claim 13, the coating step comprising a dip coagulation coating process.

17. The method of claim 13, the coating step comprising impregnating or coating the web of fabric in a polymer.

18. The method of claim 17, where the polymer is a polyamide.

19. The method of claim 13, further comprising the step of introducing the web of fabric into a coagulation bath of water and a quantity of dimethylformamide.

20. A low tensile strength tag comprising:
a coated non-woven base material configured to be coupled to at least one item and having a tensile strength of between 90 N and 150N.
